(19) United States
(12) Patent Application Publication
(10) Pub. No.: US 2014/0025343 A1
(43) Pub. Date: Jan. 23, 2014

(54) Solar Panel Layout and Installation

(71) Applicants: David Charles Gregg, San Diego, CA (US); Fabrice Mario Murgia, San Diego, CA (US); Burak Seydioglu, San Deigo, CA (US)

(72) Inventors: David Charles Gregg, San Diego, CA (US); Fabrice Mario Murgia, San Diego, CA (US); Burak Seydioglu, San Deigo, CA (US)

(73) Assignee: CITIZENRE CORPORATION, San Diego, CA (US)

(21) Appl. No.: 13/551,863

(22) Filed: Jul. 18, 2012

(51) Int. Cl. G06F 17/50; G06F 3/048

(52) U.S. Cl. 703/1

(57) ABSTRACT

Methods, computer readable media, and apparatuses related to a solar panel layout and installation software tool are presented. In certain aspects, information is retrieved from one or more data sources based on a received location. The retrieved information may correspond to satellite images of the location, climate data for the location, data describing one or more physical structures at the location, and additional information relating to technical or financial considerations of potential solar panel layouts and systems. A user interface may be displayed including a graphical representation of the location and any physical structures at the location, and including a plurality of user options for designing one or more solar panel layouts at the location based on the retrieved information corresponding to the location.

### TECHNICAL FIELD

Aspects of the disclosure generally relate to computing devices, systems, and computer software, and user interfaces. In particular, one or more aspects of the disclosure generally relate to devices, systems, and software that may be used by various different users for designing and installing solar panel layouts.

### BACKGROUND

Solar panels, also known as photovoltaic (PV) panels, may be installed as part of a system for capturing and storing energy from light using solar cells. Solar panels may be configured as free standing installations or may be installed onto various types of structures. Solar panel installations may include multiple different components, such as, for example, frames, inverters, batteries, and the solar panels themselves.

In general, solar panel systems that capture and store more energy, systems that are more efficient, and systems that are more cost-effective are preferable to systems that capture and store less energy or are less efficient or cost-effective. A variety of factors and considerations may be taken into account when designing, installing, using, and maintaining solar panel systems. For example, geographic considerations such as climate, weather, and smog, as well as technical considerations relating to the types of solar panel components may be relevant factors with respect to whether a solar panel system is more or less efficient and/or cost-effective. Various financial considerations may also be relevant for the design and operation of different solar panel systems. Additionally, certain rules and regulations may permit certain solar panel systems and prohibit others in various locations.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to methods, computer readable media, and apparatuses for use in designing and installing a solar panel layout. For example, by implementing one or more aspects of the disclosure, a solar panel layout design and installation software tool, with one or more associated user interfaces, may be provided for creating solar panel layouts on land and/or physical structures at a location. Information may be retrieved from one or more data sources based on an input address or geographic coordinates corresponding to the location. The retrieved information may include, for example, climate data for the location, data describing one or more physical structures at the location, and additional information relating to technical or financial considerations of potential solar panel layouts at the location. A user interface potentially may be provided including a graphical representation of the location and any structures at the location, and including a plurality of user options for designing one or more solar panel layouts at the location based on the retrieved location information and other factors.

According to one or more aspects, a satellite image may be retrieved for the location from a satellite image database and used in a graphical user interface to allow users to design a solar panel layout on the land and/or physical structures at the location. The satellite image may be directionally oriented and/or labeled within the user interface to allow users to take sun angles and other directional factors into consideration. Additionally, solar panel layout software implementing one or more aspects of the disclosure may identify a recognizable object of a known size within the satellite image and determine a physical size scale for the satellite image based on the recognizable object.

According to additional aspects, after solar panel layout has been selected for a location, one or more applicable forms may be identified, retrieved, and prepared by solar panel layout and installation software. The applicable forms, for example, a customer contract, permit applications, solar panel component order forms, rebate and tax forms, may vary based on the location, the selected solar panel layout, and other factors.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented.

FIG. 1B illustrates another example operating environment in which various aspects of the disclosure may be implemented.

FIG. 2 is a flow diagram illustrating a method of selecting a solar panel layout via a computer user interface according to one or more illustrative aspects described herein.

FIG. 3 shows an example of a database table storing illustrative solar panel layout and installation data based on location.

FIGS. 4A-4C illustrate examples of a computer user interface for selecting a solar panel layout according to one or more illustrative aspects described herein.

FIG. 5 is a flow diagram illustrating a method of selecting solar panel components and/or a solar panel layout via a computer user interface according to one or more illustrative aspects described herein.

FIGS. 6A-6E show screenshots of an example computer user interface for selecting a solar panel layout according to one or more illustrative aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

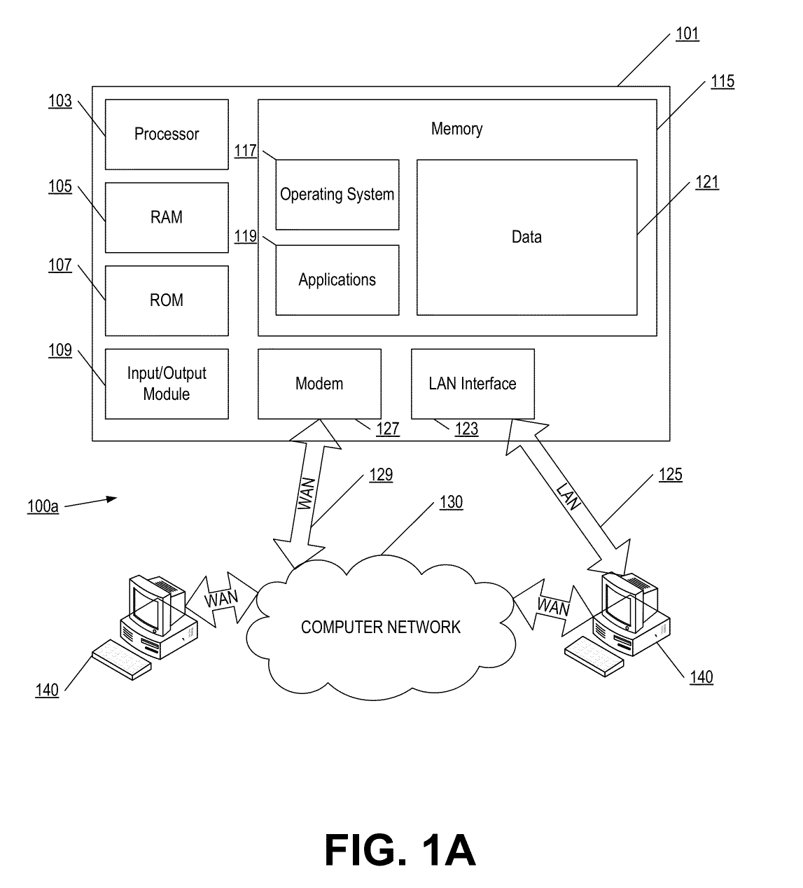

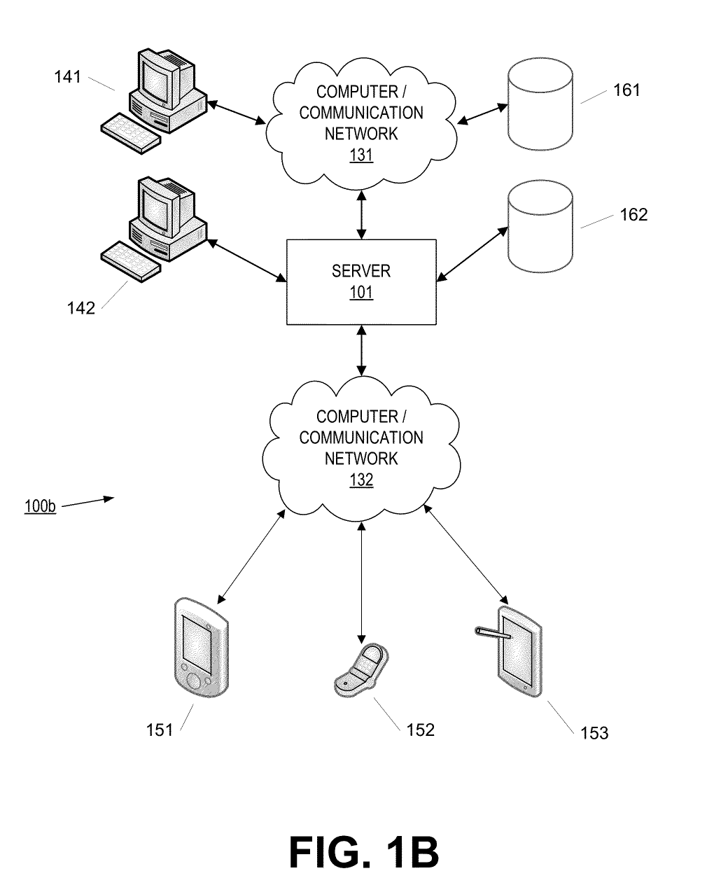

FIG. 1A illustrates an example block diagram of a generic computing device 101 (e.g., a computer server) in an example computing environment 100a that may be used according to one or more illustrative embodiments of the disclosure. According to one or more aspects, generic computing device 101 may be configured to provide a software tool having a computer user interface for designing and selecting solar panel layouts. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 140. The terminals 140 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as computer network 130 (e.g., the Internet). It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 140 may also be mobile terminals (e.g., mobile phones, smartphones, PDAs, notebooks, etc.) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. In general, such environments may include one or more computing devices, each having the components of the example computing device 101 discussed above in reference to FIG. 1A, the computing devices being connected via one or more communication networks (e.g., the Internet or other suitable computer or communication networks). In system 100b, server 101 may be any suitable server, processor, computer, or data processing device, or combination of the same. Server 101 may configured to communicate with one or more client workstations 141 and 142 in a client-server architecture, for example, by providing software services and applications (e.g., including one or more computer user interfaces) and receiving and processing the instructions received from and the transactions entered into by users via the client workstations 141 and 142. Client workstations 141 and 142 may be, in some examples, connected by one or more direct communications links to the server 101, or may be connected via one or more computer/communication networks 131 (e.g., the Internet, WAN, or LAN computer network) that may be linked via communications links to server 101. Mobile devices 151-153 may also be may connected to the server 101, either directly and/or via a second computer/communication network 132 (e.g., the Internet, or a mobile/cellular communication network), which may be the same or different from the first network 131.

In some examples, the client workstations 141-142 and/or mobile devices 151-153 may correspond to the same user, company, or entity as the server 101. Thus, the communications between the workstations 141-142 and the server 101, and/or between mobile devices 151-153 and the server 101, may be over a secure trusted network. In other examples, the client workstations 141-142, mobile devices 151-153, and the server 101 may be at remote locations and/or may be controlled by different entities, and the communications between these devices may be secure and/or encrypted transmissions over a public network 131.

According to one or more aspects, the devices and networks of system 100b may be configured to provide a software tool having a computer user interface for designing and selecting solar panel layouts. Various functionality of the system 100b may be located within the server 101 and/or may be located remotely from the server 101. For instance, the server 101, client workstations 141-142, and/or mobile device 151-153 may each be configured with client-side functionality to allow users to interact with the software tool and create solar panel layouts from their respective devices. For example, client workstations 141 and 142 may be used by specially trained in-house designers to perform a solar panel layout for customers based on information received from the customers or on-site personnel in the field via mobile devices 151-153. Additionally or alternatively, one or more client workstations 141 and 142 may be located at a customer's home or office, and the client-side functionality for the software may be directly accessible to customers (e.g., over the Internet) to design solar panel layouts. In certain examples, mobile devices 151-153 may be used in the field to provide direct information about a home, building, or other structure(s) at a location to the server 101, which may then be used by the client software to create a solar panel layout for the location. Additionally, mobile devices 151-153 may also be used as client devices configured to interact with the server 101 to create solar panel layouts. Mobile devices 151-153 may have limited functionality (e.g., displays, input/output) compared to client workstations 141-142, and thus the user interface features and other client functionality may be limited for mobile devices 151-153.

As described in more below, the system 100b may include one or more databases 161-162 to provide the server 101 with information about the locations and/or physical structures. For example, after the locations and structures are selected for designing a solar panel layout, the server 101 may access databases 161 and 162 to retrieve information regarding the locations and physical structures, and may then analyze that information to determine which user options will be available in the solar panel layout and installation user interfaces. Databases 161 and 162 may contain, for example, climate data, building code data, rebate data, and solar panel system component cost and inventory data for various geographic regions. The databases 161 and 162 may be internal databases within the memory of the server 101 (e.g., database 121), or may be external databases accessed via a direct communication link or over a communication/computer network 131 (e.g., the Internet, WAN, or LAN computer network), or both.

As an example, the server 101 may be configured to retrieve data from four separate databases, each of which may correspond to database 161 and/or database 162 and/or one or more additional databases: (1) an internal customer database maintained at the server 101 which stores names, addresses, and account information (e.g., current and recommended solar panel layouts, etc.) for customers and potential customers, (2) an external weather database maintained by an independent weather service that can be accessed by the server 101 over the Internet that stores climate data (e.g., total and peak sun hours, temperature, precipitation, wind data, etc.) for different geographic regions, (3) a secure external database maintained by a local governmental entity that stores building codes and other regulatory data for neighborhoods and buildings within its locality, and (4) a parts and labor inventory database, which may be comprised of one or more internal or external servers that are accessible to the server 101 (e.g., over the Internet and/or via secure network connections) that stores information regarding the availability of solar panel component parts and materials (e.g., panels, frames, controllers, inverters, batteries, etc.), and additional information on labor availability (e.g., contractor schedules, etc.) to allow the server 101 to assist in scheduling installations of selected solar panel layouts.

In system 100b, computer/communication network 131 and computer/communication network 132 (along with one or more additional networks used in certain embodiments) may be any suitable computer network including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Networks 131 and 132 may include other suitable communications networks such as cable networks, dial-up or wireless cellular telephone networks, satellite networks, etc.

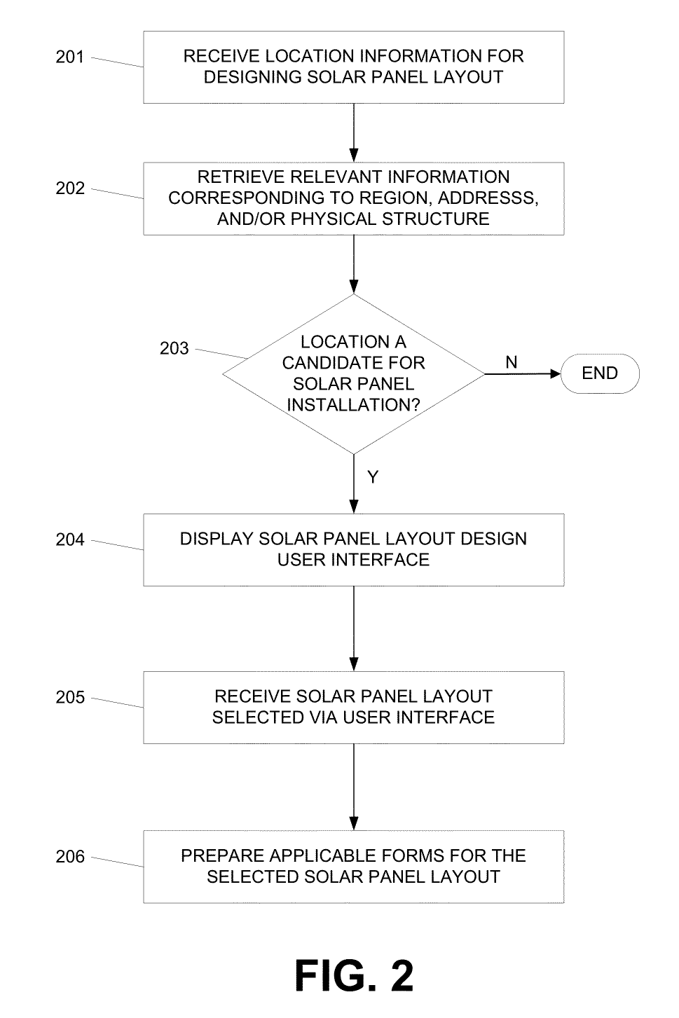

FIG. 2 illustrates a flow diagram showing a method of selecting a solar panel design via a computer user interface according to one or more illustrative aspects described herein. The embodiments described in reference to FIG. 2, and the other embodiments described herein, may be implemented by software executed on one or more computers, such as the generic computing device 101 of FIG. 1A, and/or by a computing system, such as system 100b of FIG. 1B. In at least one arrangement, the methods described herein may be performed by and/or in combination with a server (e.g., server 101). Additionally or alternatively, the methods described herein may be performed by and/or in combination with one or more workstations (e.g., workstations 141-142) and/or in combination with one or more mobile devices (e.g., mobile devices 151-153).

In step 201, location information may be received, for example, by the server 101. The location information may correspond to an address with one or more physical structures for which a solar panel layout may be desired. For example, the server 101 may receive a street address, Global Positioning System (GPS) coordinates (e.g., latitude and longitude), or other identifiers corresponding to a location and/or physical structure(s). If a street address is provided, the server 101 may access a map service and/or geographic database to determine the GPS coordinates of the address, or vice versa. The location information may be input and transmitted to the server 101 in a number of ways. For example, a designer at a client workstation 141 or 142, a customer, or an on-site representative (e.g., salesperson) with a mobile device 151-153 may input a location address or GPS coordinates into a user interface, for example, into a client-side web-based application or into a standalone software application.

The user entering the location information may be a customer entering his/her own home address or other location, or may be a specialized employee entering location information to design a solar panel layout for customers and potential customers. For instance, if the solar panel layout software tool is designed to be used directly by customers, the server 101 may allow customers to log in by providing an email address, or by creating or accessing an existing account using a unique username and password or other authentication credentials. The customer may then enter their address or GPS coordinates into a user interface screen provided by the server 101 in order to access the solar panel layout software. In other embodiments, if the solar panel layout software tool is designed to be used by specialized employees only, the user at client workstation 141 or 142 may be a salesperson or other specialist securely logged in to the server 101. For example, a salesperson may receive the customer's address from the customer (e.g., by phone, email, etc.), and may forward the address to a designer at a workstation 141 or 142 to prepare the design of the solar panel layout for the customer's location.

In certain examples, on-site field personnel (e.g., door-to-door salespersons, neighborhood scouts or surveyors, maintenance personnel servicing existing customers, etc.) may use mobile devices 151-153 to communicate the customer's location information back to the server 101 and/or to other personnel (e.g., designers) at a workstation 141 or 142. For instance, a door-to-door salesperson may carry a mobile device (e.g., Tablet 153), manually input a customer's street address into the mobile device 153, and then transmit the customer's address to a designer at workstation 141, or to a database 121 to be stored at the server 101 for later use. In other examples, the customer's address or location information may be determined and transmitted automatically by a program on the mobile device 153. For example, a salesperson may use a mobile device 153 that includes a GPS unit, and may invoke a map program that displays a satellite image of the salesperson's current position and allows the salesperson to select a location on the image (e.g., by clicking or touching the screen). The map program may identify the address and/or coordinates of the selected customer location based on the screen position selected by the mobile device user.

In step 202, the sever 101 may retrieve relevant information corresponding to the location received in step 201. The information retrieved in step 202 may be associated with the location itself (e.g., physical characteristics of the land, climate data, building codes and land use rules and regulations, etc.) and/or may correspond to characteristics of one or more physical structures at the location (e.g., sizes and shapes of buildings, structural integrity and materials used, angles and orientations of various surfaces, etc.). The information retrieved in step 202 may include many different types of information, and may be retrieved from many different data sources. For example, climate data for the location or region, including temperatures, total sun hours, peak sun hours, precipitation, pollution, etc., may be retrieved from one or more online climate databases. Building codes or covenants associated with the location (e.g., state or local regulations, home owner's association agreements, etc.) may be retrieved from one or more governmental or other organization databases. Structural details, blueprints, floor plans, and the like, for physical structures at the location may be retrieved from local governmental registries and other data sources.

Additional types of information retrieved in step 202 may relate to potential solar panel installations at the location. For example, databases of different solar panel suppliers (e.g., within a geographic region or a distance radius relative to the location) may be queried to determine the current availability of solar panel system components and materials that potentially could be used at the location, such as solar panels, frames, controllers, inverters, batteries, and other components. Additionally, the data sources of the necessary labor resources (e.g., materials delivery services, designers, contractors, and installation personnel, etc.) may be queried to determine the schedules of these labor resources for a potential solar panel installation at the location. Information regarding governmental rebates and relevant tax codes for a potential solar panel installation also may be retrieved, for example, from one or more government databases and/or other data sources.

In step 203, the data retrieved in step 202 for the location may be analyzed to determine if location is a candidate for a solar panel installation. That is, one or more pieces of information retrieved in step 202 may be analyzed using any one of several techniques and algorithms for classifying a location or structure as a potential solar panel installation candidate. As shown in FIG. 2, the determination in step 203 may be a binary determination (i.e., Yes/No) corresponding to whether or not a location or structure is a candidate for a solar panel installation. However, this determination also may be a rating system including several levels of granularity (e.g., non-candidate, fairly good candidate, good candidate, very good candidate, great candidate, etc.) or a numeric rating system (e.g., 1-100 rating scale, percentile rank compared to other locations, dollar amount of expected financial returns of solar panel installation, etc.).

As another example, the determination in step 203 may comprise separate technical and financial determinations. For instance, a location having unfavorable climate data, insufficient structural (e.g., roof) support, and/or restrictive building codes or covenants which prohibit the installation of solar panels may be identified as an unacceptable candidate (or non-candidate) for a solar panel installation based on one or more of these ‘technical’ factors, that is, factors relating to the technical feasibility of the solar panel installation and the amounts of energy expected to be stored from such installations.

In another example, a location may be a candidate for solar panel installation based on these technical factors, but other data received in step 202 may indicate that a solar panel installation might not be cost effective at the present time. For example, after retrieving and analyzing the structural requirements for buildings at this location, the cost and availability of needed materials (e.g., panels, frames, controllers, inverters, batteries, etc.), and the applicable governmental tax and rebate information for potential solar panel installations at this location, the server 101 may determine that a solar panel installation is not currently cost effective. For instance, if a structure includes several accessible and properly-oriented surfaces, and receives a large amount of sunlight at peak hours, but the required frame for the structure is currently on back order, or if there no contractor available for installation in next several weeks, or if one or more governmental entities (e.g., city, county, state, or federal programs) are not currently offering sufficient solar panel installation incentives, then the server 101 may determine this location is a good candidate for a solar panel installation, but that the installation might not be cost effective at the present time. In this example, if a binary determination is used in step 203, then this illustrative structure could either be considered a candidate (203:Yes) or a non-candidate (203:No) depending on the algorithm used.

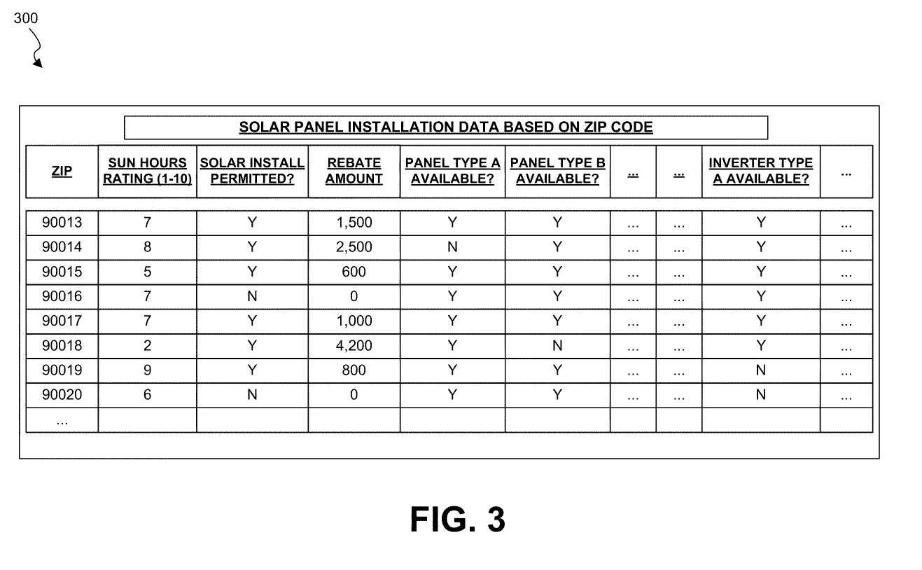

In other cases, the server 101 may retrieve and analyze the relevant information and may determine that the location is a good candidate for a solar panel installation (or a fairly good, good, very good, great candidate, etc., depending on the data analyzed and the rating scale used). As indicated above, the determination of a good candidate may include an analysis of technical factors (e.g., climate data, sun hours, building codes, etc.) and/or financial factors (e.g., prices and availability of solar panel components, governmental rebate information, etc.) in various combinations. For instance, FIG. 3 shows an illustrative database table 300 including a set of relevant data for solar panel layouts and installations based on zip code. The example table 300 may be stored within a single database 161 or 162, or may be derived based on information retrieved from multiple different databases 161 and 162 and/or other internal and external data sources. In this example, the determination of whether a location is a good candidate for a solar panel installation is done based on the zip code of the location. Using table 300, a location zip code look-up may be performed to retrieve a list of the relevant data factors for that zip code relating to potential solar panel installations. In other examples, the relevant solar panel installation data may be retrieved from different tables and/or databases 161 and 162, and may be indexed by other location data (e.g., GPS coordinates, neighborhood, city, county, state, etc.).

In certain examples, it may be sufficient to analyze a single data factor or single piece of information to determine whether or not a location is an acceptable candidate. For instance, in a particular system, if the hours of peak sun exposure for a location are below a certain threshold, then the algorithm employed may determine that no other factors need to be considered in order to determine that the location is a not an acceptable candidate. In other cases, a combination of data factors from the retrieved information may be used. For example, in another system, only if the hours of peak sun exposure are above a certain threshold, and an available governmental rebate for the solar panel installation is above a certain threshold, and the prices of necessary installation materials are currently on sale less than a certain price threshold, then the algorithm used may determine that the location may be an acceptable candidate.

As described below in reference to step 204, the determination of step 203 may determine whether or not a solar panel layout design user interface is displayed. For example, if a location or structure is determined to be an acceptable candidate for at least one solar panel installation (203:Yes), then the information for that location may be transferred to a designer, loaded into a design user interface, or stored in a database for later use, etc., whereas information for locations or structures determined not to be an acceptable candidates (203:No) might not be similarly stored or used. However, it should be understood that step 203 is optional, and in certain embodiments a designer or other user (e.g., customer, salesperson, etc.) may be able to use a solar panel layout designer for locations that have not been analyzed as described above in step 203, or even for locations that have been analyzed and have been determined to be non-candidates for solar panel installations.

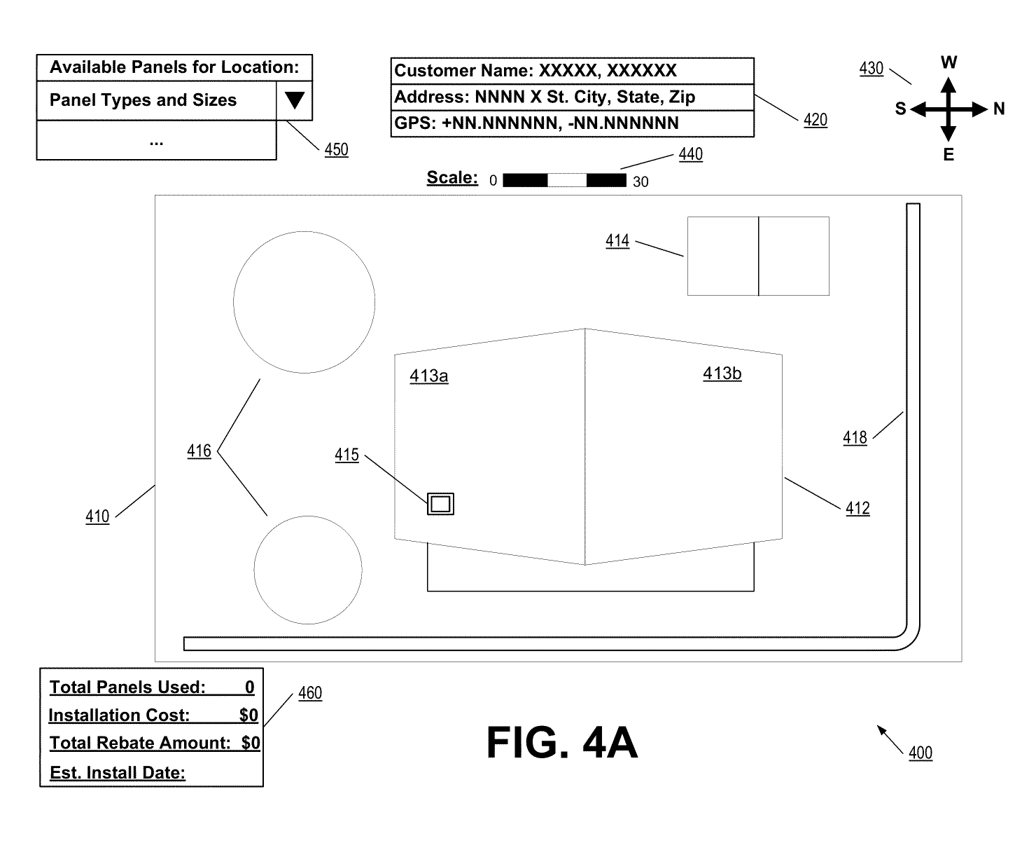

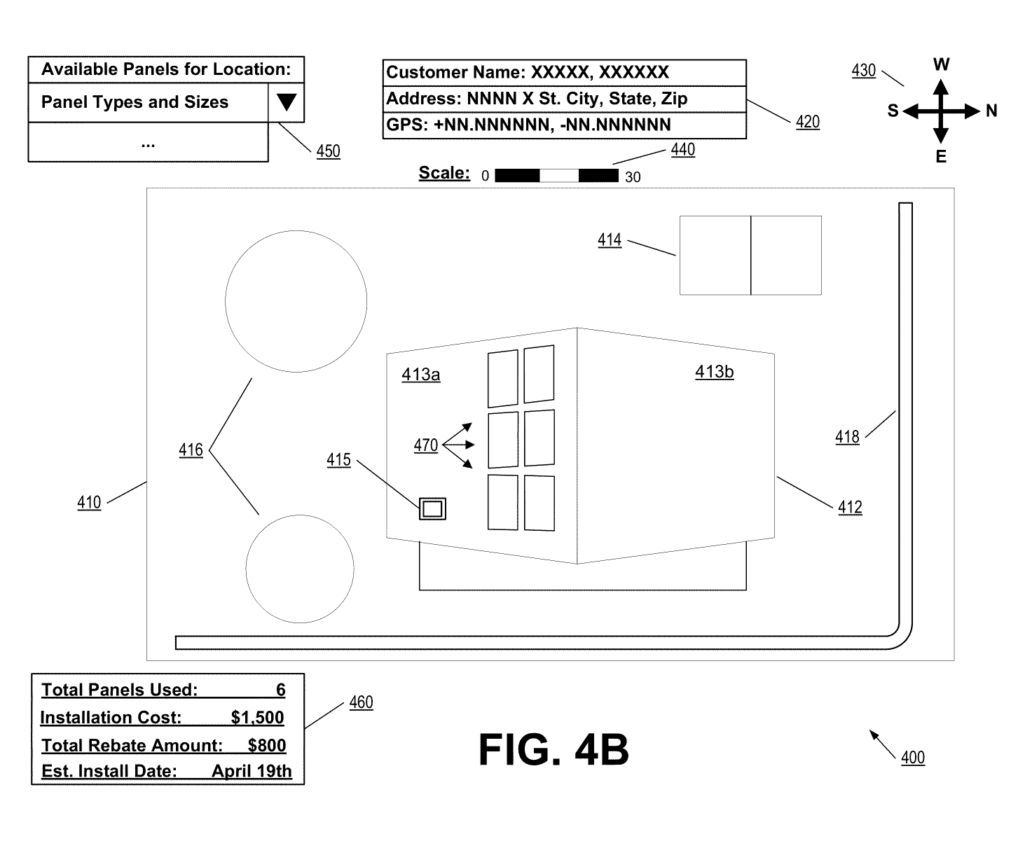

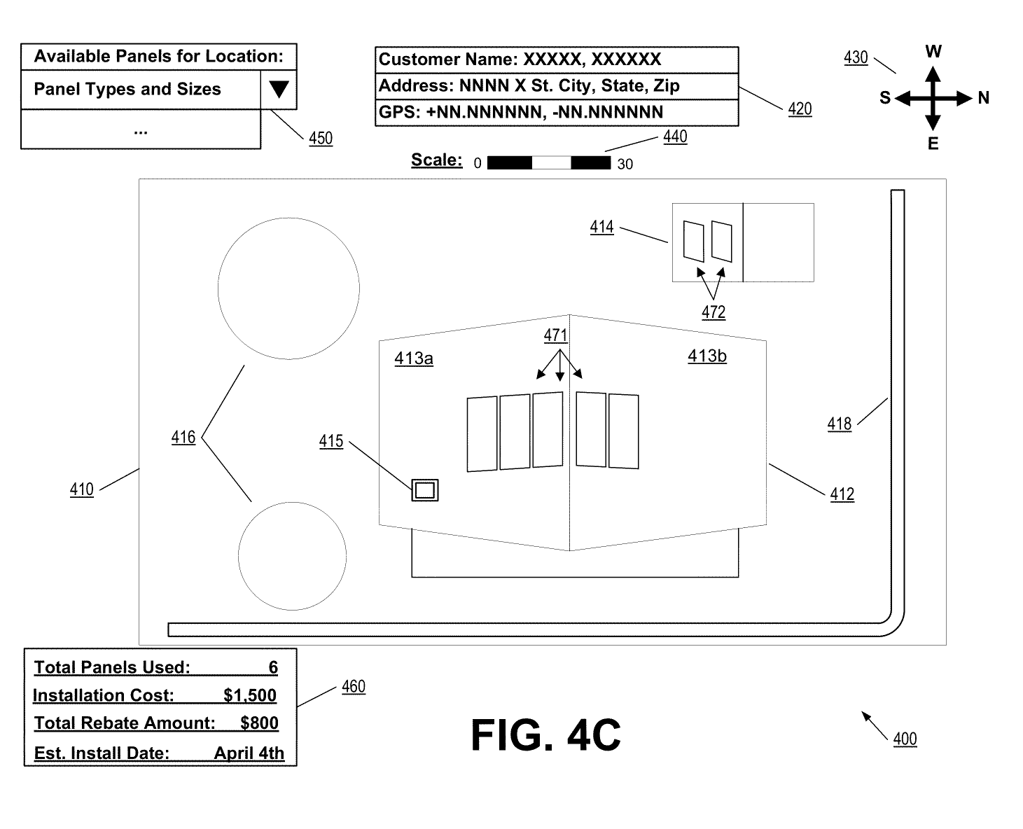

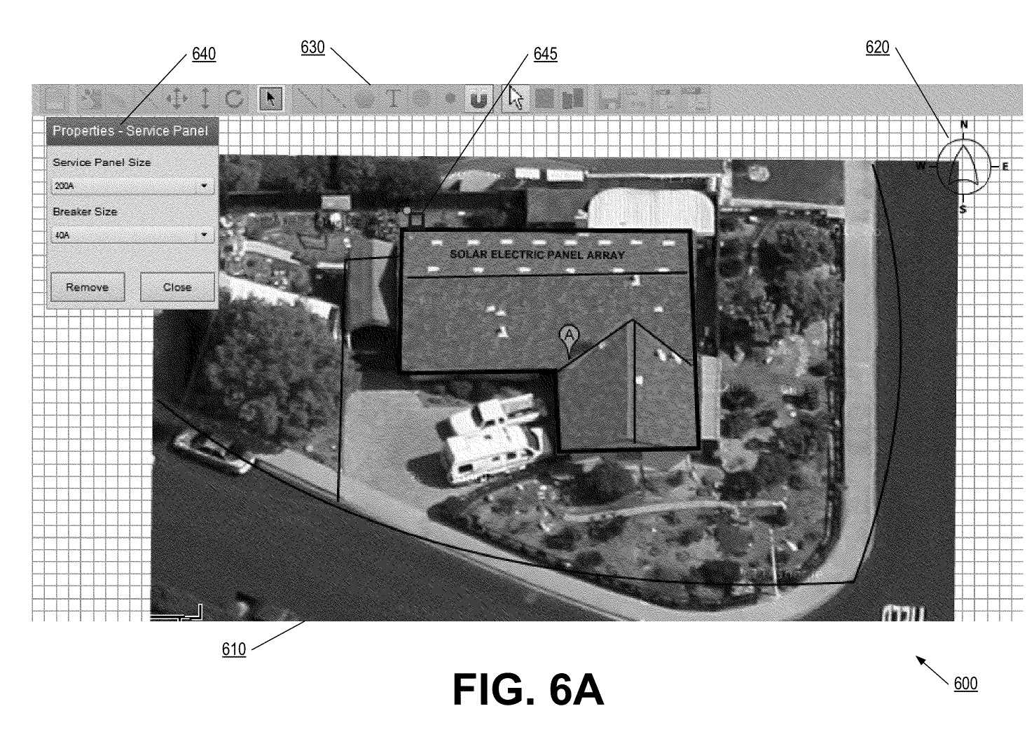

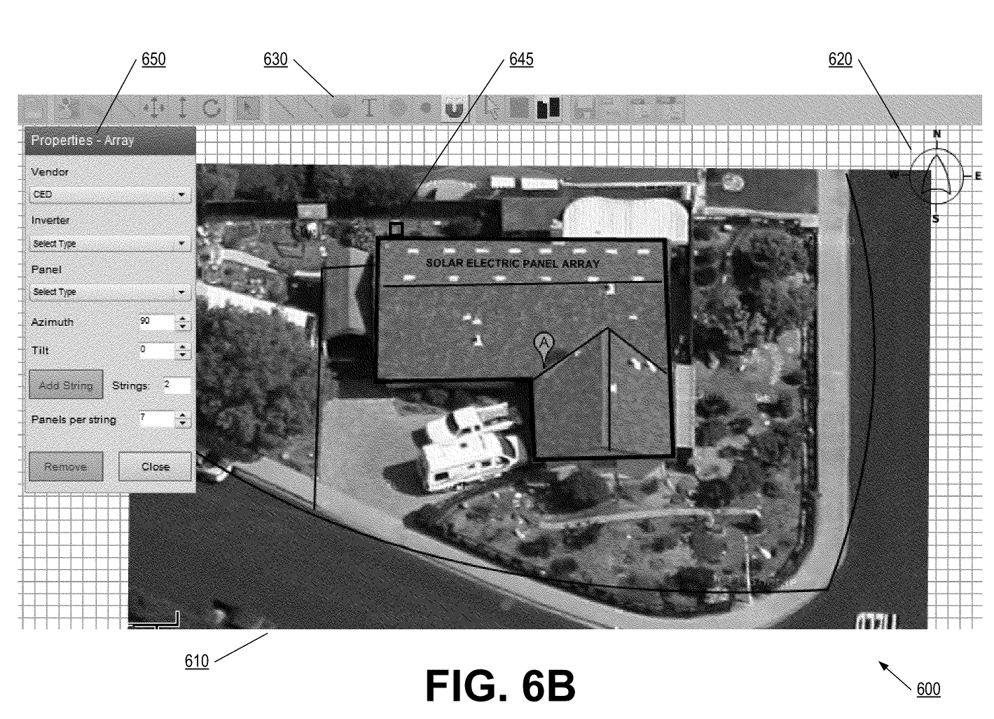

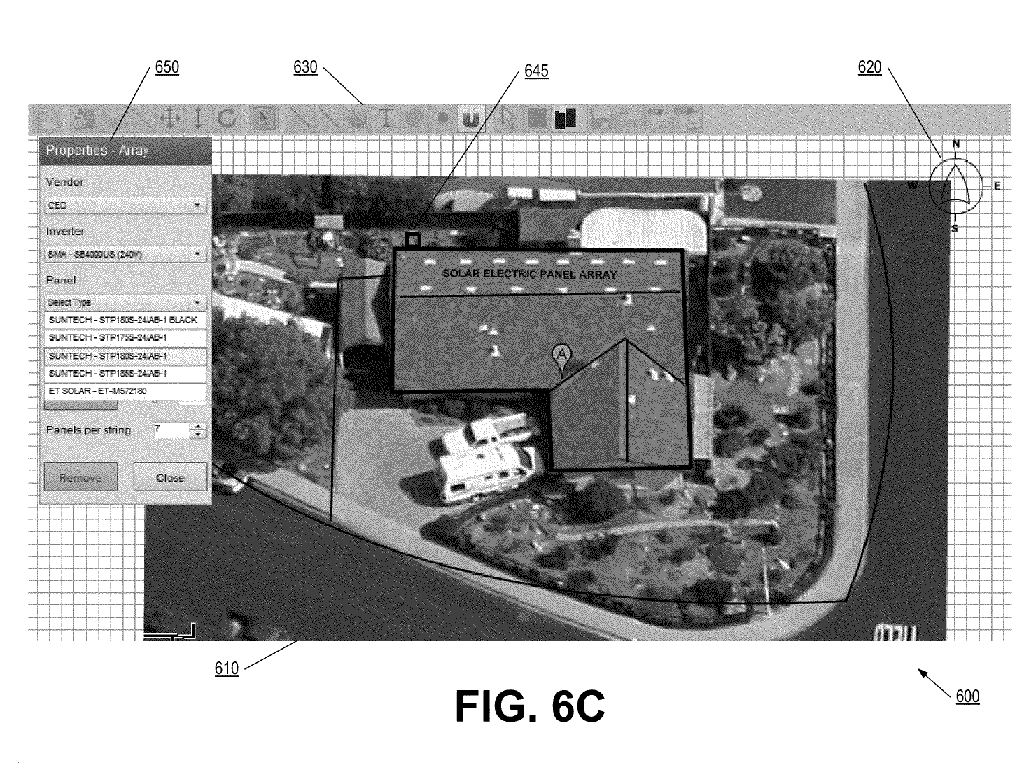

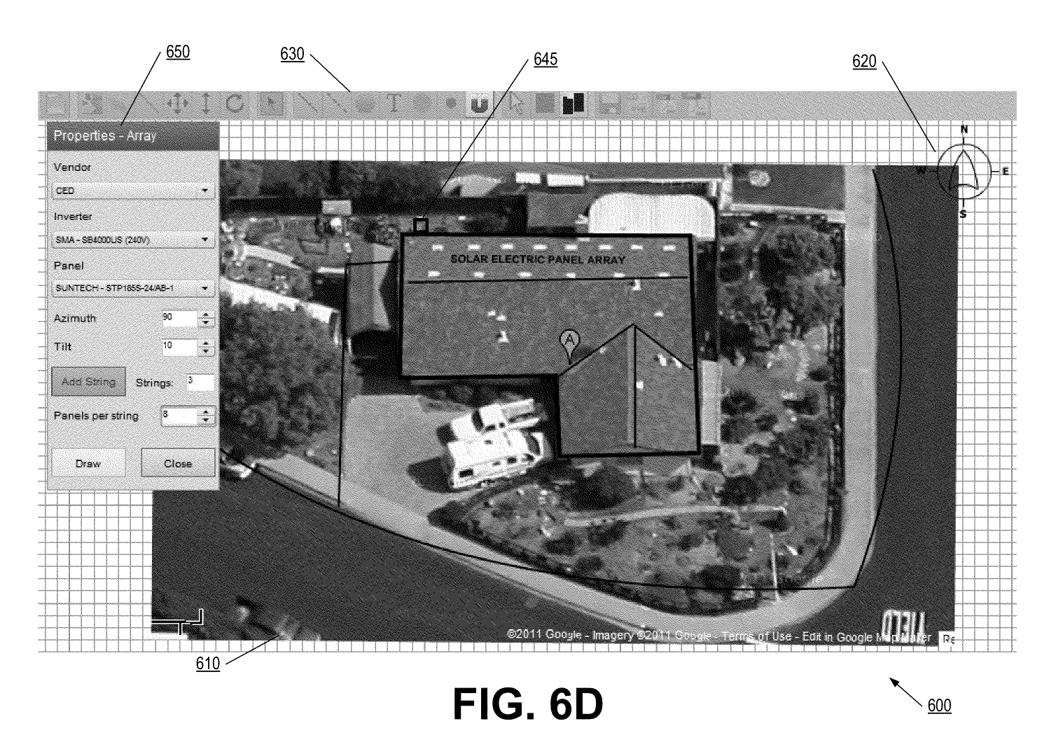

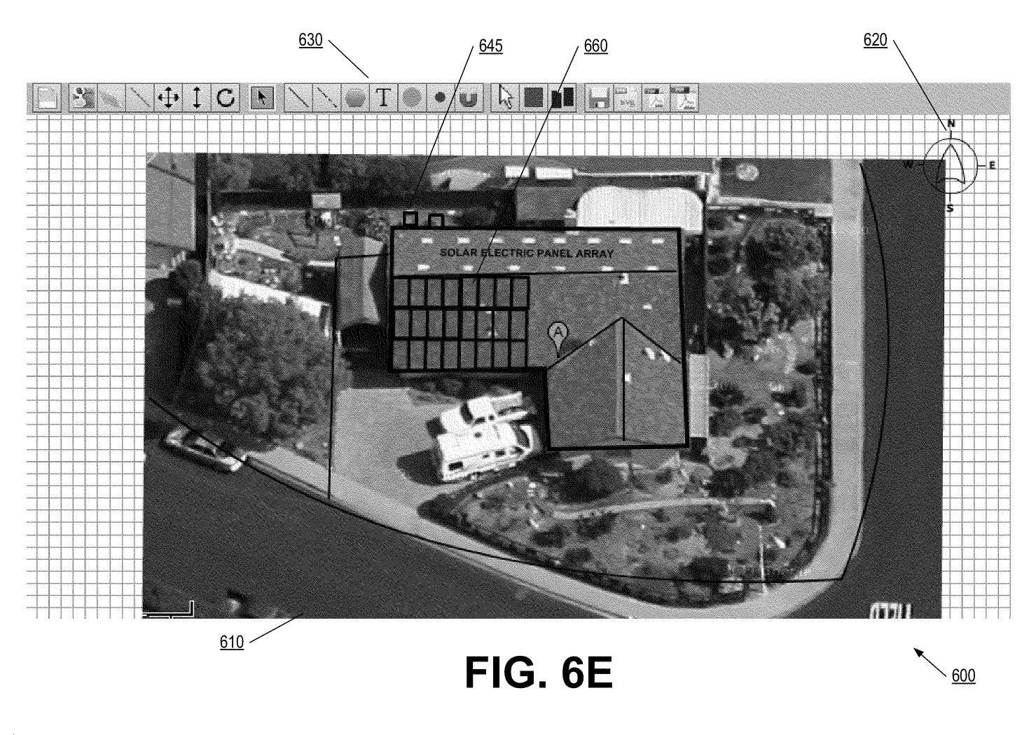

In step 204, if a location and/or physical structure at a location is determined to be an acceptable candidate for a solar panel installation (203:Yes), then any known or retrieved data for the location and/or structure may be used to configure a design user interface of a solar panel layout and installation software tool. Examples of user interface screens and features of a solar panel layout and installation software tool are shown in FIGS. 4A-4C and 6A-6E. As described above, a solar panel layout and installation software tool may provide an initial user interface which may allow users to enter location information in step 201. For example, a user interface may be generated for a salesperson or customer/homeowner immediately after inputting an address or GPS coordinates into an initial user interface screen. In other examples, the server 101 may generate different user interface screens which may be used by different users at different times. For instance, an advanced user interface may be generated and configured for a specially trained solar panel layout designer or engineer, who may log in and access the user interface after a location is input by a customer or on-site salesperson and after corresponding location information is retrieved by the server 101. Thus, trained off-site designers may design solar panel layouts geographically remotely and/or temporally remotely from when the location information is input and the relevant data is retrieved. In other examples, the server 101 may provide a design user interface to on-site or off-site designers in step 204, immediately after the location is entered in step 201 and the corresponding information is retrieved in step 202, so that solar panel layouts potentially may be designed for customers by on-site sales personnel and/or off-site designers in real time.

After the user/designer interacts with the user interface provided in step 204 to select a solar panel layout, the server 101 may receive the user selected layout in step 205 and may prepare and process the appropriate forms for the selected layout in step 206. Before discussing steps 205-206 in more detail below, the following paragraphs describe the example user interface screens shown in FIGS. 4A-4C and associated features that may be used in one or more embodiments of a solar panel layout and installation software tool.

In certain embodiments, one or more user interfaces for a solar panel layout and installation software tool may include a digital representation of the structures and/or land at the location on which a solar panel layout may be designed. For example, the server 101 may retrieve a digital image of the location from a satellite image database (e.g., Google Maps®, Google Earth®, Bing Maps®, MapQuest®, etc.) using the address or GPS coordinate information entered by the user in step 201, and may display the aerial image in the user interface to allow users to view the land and top-facing surfaces of the physical structures on the land. If a satellite image is not available, or in addition to the available satellite images, other image data may be retrieved and displayed in the user interface, for example, images from aerial surveys other various overhead images of the location, or images taken by an on-site salesperson or surveyor. Examples of a satellite image displayed in a user interface are shown in FIGS. 4A-4C and 6A-6E, which are discussed detail below.

In other examples, instead of or in addition to displaying satellite images of locations, other graphical representations of the land and structures at the location may be displayed as well. For example, if topographic or elevation data is available for a location, the server 101 may render a relief map of the land on the design user interface. A relief or topographic map may provide certain advantages, for example, when designing a solar panel layout for a standalone solar panel system (i.e., not installed on another structure), for prospective structures (e.g., structures not yet built, structures under construction), or when features of the land (e.g., hills, slopes, rocky terrain, etc.) may affect the potential designs of solar panel layouts on the structures and/or at the location.

Referring to FIGS. 4A-4C, a series of drawings is shown representing an illustrative computer user interface 400 that may be used to select solar panel designs. In these examples, an aerial view digital representation of a property 410 is shown. As described above, the digital image 410 may be satellite image retrieved by the server 101 from an external satellite image database, for example, a Google Maps® database 161. In this example, the property shown in image 410 includes a primary structure 412 (e.g., a house), a secondary structure 414 (e.g., a shed or garage), and two trees 416. The house 412 has two primary roof surfaces 413a-413b, and a chimney 415 on the south-facing surface 413b. The solar panel layout and installation software tool may allow users to visually recognize and label these items, and others, within the user interface 400. The solar panel layout and installation software may also include functionality to automatically recognize these items and others within a digital image 410 (e.g., buildings 412 and 414, roof surfaces 413a and 413b, chimney 415, trees 416, sidewalk 418, as well as driveways, skylights, vents, etc.) and automatically label those items within the user interface 400, without requiring the user to manually identify and label these items.

The illustrative user interface 400 of FIGS. 4A-4C includes several additional components aside from the digital image of the property 410. In this example, user interface 400 also includes a text box 420 displaying information about the property 410, such as the name of the customer or prospective customer, the address of the property 410, and the GPS coordinates of the property 410. A compass 430 may also be provided on the user interface identifying the cardinal directions with respect the location image 410, to allow the user consider the proper orientation in designing the solar panel layout. For example, in the northern hemisphere, it may be advantageous for designers to know which direction is south in the displayed image so that the designers can identify which surfaces will receive more direct sunlight and which surfaces will receive less direct sunlight during different times of the year. Thus, the compass 430 may be added manually by the user or provided automatically by the solar panel layout and installation software. For example, a property image 410 may be retrieved from a satellite image database 161 in which all of the images are oriented in the same direction (e.g., north facing up), thus allowing the server 101 to display and orient the image 430 and/or draw the compass 430 correctly. The orientation of the image 410 and/or compass 430 also may be provided based on information about the property received from on-site personnel (e.g., a surveyor or salesperson). For example, the on-site personnel may transmit an address or GPS coordinates along with the directional orientation of a structure or landmark on the property, to an off-site designer who may add the compass manually via the user interface 400.

The user interface 400 also includes a scale 440. In certain examples, the scale may be determined based on the scale of the satellite image retrieved by the server 101 from an external satellite image database (e.g., Google Maps®, Google Earth®, Bing Maps®, MapQuest®, etc.). In other examples, the scale may be calculated and displayed automatically by the solar panel layout software based on a known size or distance of an item in the property image 410. For example, the solar panel layout software may be configured to identify a sidewalk 418 within the property image 410, and then to calculate the scale 440 for the image 410 based on a predetermined known width of the sidewalk 418. In this example, the solar panel layout software may assume that the sidewalk is a standard width (e.g., 5 feet) or may retrieve the sidewalk width from an external source (e.g., an architectural plan or schematic for the displayed property or nearby properties, neighborhood design plans, local government rules or regulations, etc.). The scale 440 may be calculated and rendered based on other known lengths or widths of items in the image 410, such as known sizes of buildings, cars, driveways, etc. In these examples, the width of the 418 sidewalk or other any distance may also be provided by on-site personnel, for example, a salesperson who measures a property line, sidewalk, driveway length, etc., and then inputs that distance via a user interface to the server 101.

As shown in FIGS. 4A-4C, the solar panel layout and installation software tool may also provide a solar panel menu 450 in the user interface 400 to display one or more lists of the solar panels that are available at the displayed location. In this example, the solar panel menu 450 may be a dropdown list including the different available types and sizes of solar panels that the user may select for the location shown in image 410. The list of available panels displayed in menu 450 may be calculated by the server 101 based on several different factors. For example, based on the sizes, designs, and/or structural details (e.g., size dimensions of roof surfaces, slopes of roof surfaces, roofing materials, etc.) of the physical structures 412 and 414 at the location, the server 101 may determine that certain solar panels are incompatible or sub-optimal for these structures and may determine that the incompatible and/or sub-optimal solar panels should not be included in the set of available panels 450.

The list of solar panels displayed in the available solar panel menu 450 may be determined based on other factors instead of, or in addition to, the size and structure of the buildings 412 and 414 at the location. The server 101 may determine that certain solar panels are unavailable even if they are compatible with the size and structure of a building at the location, for example, if these panels are not permitted by a neighborhood covenant or a state or local rule or regulation. To perform this determination, the sever 101 may retrieve a set of applicable restrictions from one or more data sources (e.g., external data sources 161-162 corresponding to listings of neighborhood covenants, state and local solar panel regulations, etc.), to confirm that each of the solar panels displayed in the available list 150 complies with all known laws and covenants. Additionally, the sever 101 may determine that certain solar panels are not available for a location based limitations of the manufactures or suppliers of the panels. For example, the server 101 might only display panels in the menu 450 if the panels are supplied and available locally. Thus, solar panels provided from a remote distributor located across the country may be excluded from the list of available panels 450. The server 101 may also query solar panel manufacturers and suppliers to confirm that certain panels and other related components (e.g., frames, controllers, inverters, batteries, etc.) are available for delivery to the location at the present time. If certain types or sizes of solar panels and other components are currently unavailable or on back order, then the server 101 optionally might not list those panels types and sizes in the menu of available panels 450.

Although the example user interface 400 shows a single menu only, other examples may include additional menus and/or user interface components to guide the user through the layout design process. For example, a menu of available solar panel frames may be provided based on the sizes of roof surface 413a and 413b, roof materials, and other factors, and an available solar panel menu 450 may be provided as a submenu only after the user has selected a frame. In other examples, an available frame menu, available solar panel menu, available inverter menu, available battery menu, and menus for other solar panel components may be displayed in series or concurrently on the user interface 400.

The available solar panel menu 450 and any other menus displayed on the user interface 400 of the solar panel layout software and installation tool may also be dynamic, in that they may be updated automatically by the server 101 in response to user selections or interactions with other menus or components within the user interface 400. The server 101 may store information identifying lists of solar panels types, models, and sizes that are compatible with various other panels, frames, controllers, and inverters. For example, if a user selects a first frame type, first inverter type, or first panel type from one manufacturer via the user interface, then the other menus may be automatically updated by the server 101 to remove incompatible frames, controllers, inverters, solar panels, and other components from another manufacturer. As another example, if a user has designed a solar panel layout for a larger surface of a building, and only smaller surfaces are available, then the available solar panel menu 450 may be automatically updated by the server 101 to remove the previously-displayed larger panels that would not fit on the remaining smaller surfaces. In certain examples, components must have the same manufacturer to be considered compatible, while in other examples components from different manufacturers may be considered compatible. The determinations of component compatibility may be based on the manufacturer, size, power output (e.g., components designed to receive or output the same voltage or current level), aesthetics (e.g., color, materials used), and/or other characteristics of the various components.

In addition to determining which panels and other components should and should not be included in the available solar panel menu 450 and other menus in the user interface 400, the solar panel layout and installation software may perform additional functions, such as ranking the items within the menus and/or automatically selecting or suggesting specific items based on an analysis of one or more of the relevant factors. For example, the server 101 may determine a suggested optimal frame and/or solar panel layout based on roof surface sizes, available materials, costs, and/or other factors. The server 101 may then indicate the suggested optimal components within the user interface 400, for example, by highlighting suggested components or the placing the suggested components at the top the available panel menu 450 and other menus within the user interface. In other examples, an additional user interface component (e.g., a “Suggested Layout” button or text box) may be provided on the user interface 400 to allow the user to review and/or automatically place the suggested layout on the user interface 400. As discussed above, both the determination of suggested optimal components/suggested design layouts, and the determination of whether or not to include specific solar panels types, sizes, and other components within the user interface 400 may be based on an analysis of technical factors (e.g., climate data, sun hours, building codes, etc.) as well as non-technical or financial factors (e.g., prices and availability of solar panel components, governmental rebate and tax information, etc.) in various combinations. The determination of suggested optimal components and/or suggested design layouts may also depend on the availability of components and the compatibility matrix between different components. For example, one potential panel layout may require a combination of panels of two different sizes to cover a large roof surface. In this case, if the server 101 determines that there are available panels of the two sizes which are compatible (e.g., panels from the same manufacturer, aesthetically similar panels, and/or panels having the same voltage type), then this panel layout may be suggested (or automatically selected) as an optimal layout. However, if the server 101 determines that compatible panels of these two sizes are not available, then this panel layout might not be selected as an optimal layout.

The server 101 may use one or more optimization algorithms to suggest or select optimal layout designs and/or the solar panel installation components. An optimization algorithm may use any combination of known factors (e.g., technical or financial factors) to determine a solar panel installation that will provide a maximum projected power output. A projected power output for a potential installation may be calculated as a projected power output rate for the installation, or as a projected power amount over a time period (e.g., a number of hours, days, weeks, months, years, etc.). When calculating a projected power output, the server 101 may calculate an initial projected power output rate and/or a projected power amount over an initial time period beginning immediately after the installation. The server 101 may also perform longer term determinations, for example, projected power output rates at future points in time (e.g., 1 month, 6 months, 1 year, 5 years, etc.) after the installation, and power outputs over various time periods (e.g., 5-year projected output, 10-year projected output, 20-year projected output, etc.). Longer term determinations may take into account the projected accumulation of dirt, leaps, sap, and other substances on panels, the normal wear and tear of the components, and other factors. When projecting longer term power outputs for solar panel installations, the time periods may be automatically selected by the server 101 (e.g., predetermined time periods, or time periods based on the expected life of the hardware components in the installation, etc.), or may be configurable by a user (e.g., based on the amount time until the owner plan to sell the house, etc.). Thus, a user (e.g., designer, customer, or salesperson) may use the server 101 to suggest or select an optimal solar panel installation (including the set of components and the design layout) for a property to maximize the initial power output of the installation, and may use the server 101 to suggest or select a different optimal solar panel installation for the property to maximize the longer term power output of the installation.

Using menus and other components, the example user interface 400 may allow users to interactively create and modify solar panel layout designs for the displayed location 410. A variety of different user interface techniques may be employed to allow users to design, save, reopen, review, and modify various solar panel layouts. In the example shown in FIGS. 4A-4C, the user may select a desired panel type and size from the available solar panel menu 450, and then place the selected panel (e.g., by clicking, drag-and-drop, etc.) on a structure 412-414 or other surface on the location image 410. An example of this process is shown FIGS. 4A-4C. In FIG. 4A the user interface 400 has been displayed, but the user has not yet selected and placed any solar panels on the location image 410. In FIG. 4B, the user has selected six solar panels from the available solar panel menu 450, and positioned them in two rows of three panels 470 on the south facing surface 413a of the house 412. In FIG. 4C, the user has removed the previous configuration of solar panels 470 shown in FIG. 4B, and created a two new configurations of solar panels on the house 412 and the shed 414 on the location image 410. In the configuration shown in FIG. 4C, the user has selected different sizes and/or types of solar panels for the house 412 and the shed 414, and has positioned the panels on the house 412 in a different layout from the layout shown in FIG. 4B, including a panel set on the south facing surface 413a and a panel set on the north facing surface 413b.

In certain embodiments, the sizes and angles of the solar panels drawn on physical structures within the user interface 400 may be determined based on the size scale and/or any available structural data, for example, roof height and surface angles. For example, the solar panel layout and installation software may determine the size of the selected solar panels to be drawn within the user interface 400 based on the actually physical size of the selected solar panels and the size scale 440. Additionally, roof height or surface angle data may be available, for example, from on-site personnel or customers, or may be retrieved from data sources including architectural blueprints or structural plans of the buildings 412 and 414 at the location. For instance, if roof height data is available, then the angle of one or more roof surfaces 413a and 413b of the structures 412 and 414 may be calculated based on the upper and lower roof heights and the size scale 440. The solar panel layout software may then use the roof surface angle data to calculate how much roof surface is available on the structures 412 and 414. The sizes and angles of roof surfaces 413a and 413b also may be used to determine whether or not the structure is good candidate for a solar panel installation, and to determine which solar panel layouts are available and suggested for the physical structures 412 and 414. Additionally, when drawing solar panels onto a roof surface 413a or 413b in the user interface 400, the determined roof surface angle may be used to more accurately render the panels, for example, by changing the panel size, shape, or orientation to reflect the angle of the roof surface 413a or 413b.

In certain examples, a solar panel layout and installation tool may allow the user to consider physical obstructions (e.g., chimneys, vents, skylights) that may affect potential solar panel installations. For instance, in user interface 400, the chimney 415 may be recognized and/or labeled, either automatically by the server 101 (e.g., using image analysis and recognition software) or manually by the user interacting with the server 101 via the user interface. After the chimney 415 is recognized, a user performing a manual solar panel layout design may avoid layouts that would be interfered with by this obstruction. Additionally, when the server 101 is used to automatically select or suggest a solar panel layout, the server 101 may identify potential obstructions and may automatically select or suggest layouts that avoid the obstructions.

The solar panel layout and installation tool may also identify shading factors, for example, trees 416, chimneys 415, overhanging roof surfaces, and other physical objects that may reduce the amount of sunlight reaching solar panels in certain potential layout positions. For instance, a solar panel layout installed on a roof surface adjacent to several tall trees or a nearby chimney may receive less sunlight than it otherwise would if these shading factors were not present. Accordingly, in the user interface 400, potential shading factors (e.g., chimney 415, trees 416) may be recognized and/or labeled, either automatically by the server 101 (e.g., using image analysis) or manually by the user interacting with the server 101 via the user interface. After the shading factors are recognized, a user performing a manual design via the user interface may avoid solar panel layout designs that would be affected by the shading factors. Additionally, when the server 101 is used to automatically determine a suggested solar panel layout, the server 101 may identify potential shading factors and may select suggested layouts that avoid or minimize the shading factors. As an example, in FIG. 4B, the proposed solar panel array 470 has been positioned relatively high on the roof surface 413a, because the trees 416 are positioned just south of the house 412 and may be of a sufficient height to block the sun from the lower portions of the roof during certain times. As another example, in FIG. 4C, the proposed solar panel array 471 has been offset from the chimney 415 to prevent from the chimney from shading the array 471. A shade analysis may be performed by the server 101 for a proposed solar panel layout based on the position and height of potential shading factors, and the directional orientation of the shading factors compared to the solar panels.

As discussed above, the server 101 may determine optimal solar panel installations for a property to maximize the projected initial power output and/or longer term power output for the installation. In these cases, the recognition and analyses of trees and other shading factors may be used by the optimization algorithms to project the power output of various potential systems. When projecting an initial power output, trees may be recognized and analyzed as described above, for example, using image analyses or manual observations by users. However, when projecting the power output for a solar panel installation over a longer period of a time, the recognition and analysis of tree shading factors may include an additional tree algorithm to project changes in the shading factors for the tree over time. A tree algorithm may receive input data describing the current condition of a tree, shrub, or plant, etc., (e.g., the type, size, height, age, and/or location of a tree), and may use those factors to perform a shade analysis calculation for the tree for a future time period. The tree algorithm may access a tree database containing the average heights and growth rates for various types of trees at different ages and in different geographic regions. A tree database may also contain information regarding leaf densities, deciduousness, and other data regarding the various tree types. For example, if a small maple tree was recently planted near a house, the tree algorithm may retrieve a maple tree growth rate, density, and leaf fall timing from the tree database to project the height and shading effectiveness of the tree at any future point in time. Using the tree algorithm, the server 101 may determine that the maple tree will become a significant shading factor for one roof surface of the house in the next few years. Similarly, the tree algorithm may determine that a sycamore tree on the opposite side of the house will not become a significant shading factor for several more years, based on the type, age, height, and location of the sycamore tree.

In certain embodiments, the solar panel layout and installation software tool may display summary information 460 via the user interface 400 for a selected solar panel layout. In the example user interface 400, the summary information includes the number of panels used in the currently displayed panel layout, the installation cost of the currently displayed panel layout, the amount of the governmental rebate corresponding to the currently displayed panel layout, and an estimated installation data of the currently displayed panel layout. In this example, the installation cost in the summary information 460 may be calculated by the server 101 based on the individual panel costs retrieved from a solar panel manufacturer or supplier data source, and may also include additional component costs, installation and maintenance costs, and other costs. The governmental rebate amount information may be calculated by the server 101 based on the federal, state, local laws relating to solar panel installation. The estimated installation date for the selected layout may be calculated by the server 101 based on the availability of the components and personnel needed to perform the installation. Since the availability of different solar panel types and sizes, frames, controllers, inverters, batteries and other components, and the personnel to perform the installation may vary, different solar panel layouts may have different estimated installation dates. Therefore, based on the summary information provided by the solar panel layout and installation software, including estimated costs, rebates, installation dates, and other data, the user or designer may experiment with multiple different solar panel layouts and select a preferred layout based on the user's priorities.

Referring again to FIG. 2, after the user/designer interacts with the user interface to select a solar panel layout, the software may receive the selected layout in step 205. In certain examples, a client-server architecture of the solar panel layout and installation software tool may allow users to locally save one or more in-progress solar panel layouts, such as competing/alternate layouts for the same location or different in-progress layouts for different locations. Completed or in-progress solar panel layouts may be stored locally on a user's client workstation 141-142, at the server 101, or both. Users may reopen, review, modify, and save existing solar panel layouts before finally selecting one or more solar panel layouts for the location.

After receiving a selected solar panel layout in step 205, the server 101 may prepare a customer contract, one or more appropriate forms, and other information for the selected layout in step 206. For example, a parts list, various permit applications, and/or installation order forms may be generated by the server 101 for the selected solar panel layout. Additionally, if the selected solar panel layout is eligible for one or more governmental rebates, the server 101 may identify the available rebates and prepare the applicable forms (e.g., local government rebate forms, state and federal tax forms, etc.). After identifying and retrieving one or more applicable forms for the selected solar panel layout, the server 101 may automatically populate some or all of the form fields with the customer information (e.g., name, address, etc.), selected panel information (e.g., number, types, size, and configuration of panels, etc.), and any other information available to the server 101. The server 101 may then output the customer contract and applicable forms to the user via the user interface and/or allow the user to print the contract and forms. In step 206, the server 101 also may perform steps to schedule the installation of the selected solar panel layout. For example, the server 101 may prepare and output a service request form for a local solar panel installer. The server 101 may also automatically contact one or more installers, for example, via email, submission of an Internet form, etc., to schedule the installation of the selected solar panel system at the customer's location. The server may also contact the customer (e.g., via email) to provide the customer contract for the solar panel installation and to schedule and/or confirm the installation.

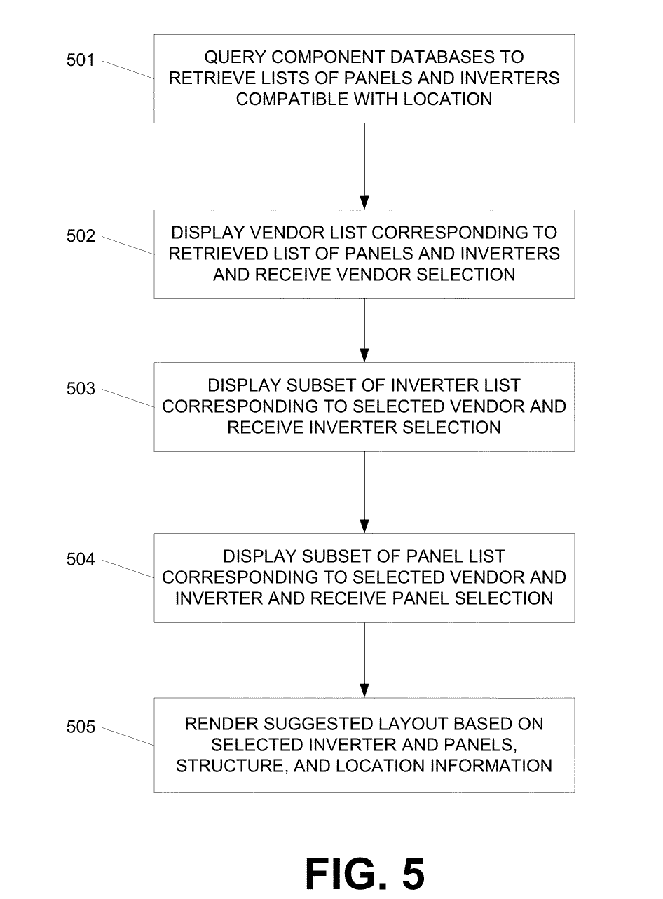

Referring now to FIG. 5, a flow diagram is shown illustrating a method of selecting solar panel components and/or a solar panel layout via a computer user interface. The steps in FIG. 5 may be performed by various user interface components, for example, drop down 450 in FIGS. 4A-4C or window 650 in FIGS. 6B-6D (described below), to allow users to dynamically select solar panel components based on the customer's location and the other relevant technical and financial factors described above (e.g., climate data, component availability and cost, governmental rebates, etc.). In step 501, the server 101 may query a solar panel component database (e.g., database 161 or 162) to retrieve a full component list of all solar panels and inverters that are compatible with a customer's location and the physical structures at that location. In step 502, a list of each vendor from the retrieved component list may be displayed in a user interface component (e.g., window 650 in user interface 600), and a first user selection of a vendor from the vendor list may be received via the user interface. In step 503, in response to the selection of a vendor in step 502, the subset of inverters from the full component list which correspond to the selected vendor may be displayed, and a second user selection of a specific inverter type may be received via the user interface. In step 504, in response to the selection of an inverter in step 503, the subset of solar panel types from the full component list which (a) are provided by the selected vendor, and (b) are compatible with the selected invertor, may be displayed in the user interface, and a third user selection of a specific solar panel type may be received via the user interface. Thus, steps 501-504 illustrate the general concept described herein of using dynamic menus and other components to allow designers to interactively select solar panel components that are determined to be compatible with the components the designer has already selected. An example of dynamic menus is also described below in reference to window 650, in FIGS. 6B-6D.

In steps 502-504, it should be understood that the interactive lists and menus of solar panel components displayed in a user interface may be based not only on component compatibility, but also other relevant factors relating to the customer's location and/or the physical structures. For example, when generating and displaying the full component list in step 502, and the component subset lists in steps 503 and 504, the user interface may remove components that are incompatible with the customer's location and/or structures based on an analysis of one or more of the technical or financial factors discussed above.

In step 505, the server 101 may invoke software to automatically determine one or more suggested solar panel layouts and/or to render the suggested layout(s) in the user interface. An example of an automatically rendered a solar panel layout may be shown in FIG. 6E, in which the solar panel array 660 may either have been manually designed and positioned by a user, or may have been automatically determined by the server 101 and rendered on the image of the house 612 in response to the user selecting the inverter and solar panel type in menu 650. As described above, when a server 101 automatically selects or suggests a solar panel layout, it may make these determinations based on the set of solar panel components (e.g., inverter, controller, panel types and sizes, battery, service panel location, etc.) that have been previously selected by the user. In other examples, the server 101 may automatically select a set of solar panel components (e.g., based on one or more technical and/or financial factors) that may be preferred or optimal for a potential solar panel layout. The server 101 may then determine and render a solar panel layout on the user interface using the automatically selected components.

Referring now to FIGS. 6A-6E, a series of screenshots is shown for another example computer user interface 600 for selecting a solar panel layout. As in the previous example, the user interface 600 of FIGS. 6A-6E includes an aerial representation of a property 610, in this case, a satellite image of a house. The user interface 600 also includes a directional compass 620, and a toolbar 630 containing a set of features and options for designing a solar panel layout. For instance, the user interface 600 may include options and features (e.g., buttons on toolbar 630) that allow users to draw lines and text labels on the location image 610, as shown in FIGS. 6A-6E.

In FIG. 6A, the solar panel layout user interface 600 shows a service panel properties window 640. In this example, the user may have selected a service panel button from the toolbar 630, allowing the user to place a service panel icon 645 on the location image 610 at the correct location of the house's service panel. The same button on the toolbar 630, or a different user interface component, may be used to invoke the service panel properties window 640 which may allow the user to define the service panel size and breaker size for the house, as well as other service panel properties. In certain examples, the service panel size and location, breaker size, and other service panel properties may be relevant to a solar panel system designer in deciding which solar panels types, components, and solar panel system positions can be and should be used at the location 610. Therefore, the user interface 600 may allow users to define a service panel location and size before placing solar panels on the location image 610.

In FIG. 6B, the solar panel layout user interface 600 shows a solar panel array drawing window 650. The window 650 may have been drawn on the user interface 600 in response to a user selecting a corresponding icon from the toolbar 630, or other user interface component. In this example, the solar panel array drawing window 650 includes a series of three dropdown menus that allow the designer to select a solar panel type for placement on the location image 610. The first dropdown menu in window 650 contains a list of solar panel vendors. After selecting a vendor from the vendor dropdown menu, the user interface 600 may populate the second dropdown menu in window 650 with a list of inverters compatible with the selected vendor. Then, after the user selects an inverter from the inverter dropdown menu in window 650, the user interface 600 may populate the third dropdown menu in window 650 with a list of available solar panel types compatible with the selected vendor and inverter. For example, as shown in FIG. 4C, after the user has selected the vendor “CED,” and the inverter “SMA-S84000US (240V),” the user interface 600 has populated the panel dropdown menu in window 650 with a list of five available panels. The solar panel types displayed in FIG. 6C may correspond to the set of panel types that from the selected vendor that are compatible with the selected inverter. Additionally, as discussed above, the set of solar panel types displayed in FIG. 6C may also be selected based on other criteria, such as panel size in relation to structure size, cost, current availability from the vendor, and other various combinations of the technical and financial factors previously discussed.

In FIG. 6D, the vendor, inverter, and panel type have selected by the user, and these values are displayed in the solar panel array drawing window 650. The user may now set one or more additional components in the window 650 to further configure the desired solar panel layout. In this example, solar panel array drawing window 650 allows the user to define the azimuth and tilt for the desired solar panels. Window 650 also allows the user to define the number of solar panel strings and the number of panels per string that will be drawn onto the location image 210.

In FIG. 6E, after identifying the solar panel type and defining the relevant configuration options, the user interface 600 draws the selected configuration of solar panels 660 on the location image 610. The user may be able to control the location of the solar panel configuration 660 on the image 610, for example, by clicking or dragging-and-dropping the panel configuration 660 to the desired location. In this example, the user has defined a configuration of twenty-four panels in three rows on the large southern facing surface of the house in image 610. Alternatively, the solar panel configuration shown in FIG. 6E may be automatically determined by the server 101 and rendered on the user interface 600 in response to the user identifying the desired inverter and solar panel types. Thus, the server 101 may use an algorithm to automatically determine a preferred or optimal solar panel layout using the selected components, based on one or more of the technical factors described above, for example, the type and size of selected solar panel components, the roof surface size, composition, angle, and orientation, the position of the service panel(s), potential physical obstructions to the installation (e.g., chimneys, skylights, roof vents, etc.), and shading factors at potential installation positions (e.g., trees, chimneys, other overhanging roof surfaces), etc. The algorithm may also consider relevant financial factors which may be different for different potential layouts, for example, the price availability of components, governmental rebates, installation costs, etc. After determining a preferred (e.g., technically or financially optimal) solar panel layout using an algorithm, the server 101 may render the corresponding solar panel array configuration on the user interface 600.

As described above in relation to FIGS. 2 and 4A-4C, the user interface 600 may allow the user to modify or remove the solar panel configuration 660, as well as adding one or more additional sets of solar panels on the image 610. The user interface 600 may also allow the user to save, reopen, modify, and delete previously created solar panel layout designs. Additionally, after the user has completed the solar panel layout, the user interface 600 may allow the user to submit the completed layout to the server 101, and retrieve and print any applicable forms (e.g., user contracts, parts lists, permit forms, rebates, tax forms, etc.).

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. An apparatus, comprising:
at least one processor; and
memory storing computer-readable instructions that, when executed by the at least one processor, cause the apparatus to:
receive data corresponding to a location having at least one physical structure;
access a first database and retrieve information corresponding to the at least one physical structure at the location;
provide a computer user interface displaying a representation of the at least one physical structure at the location; and
provide via the computer user interface a plurality of user options for designing a solar panel layout for the at least one physical structure, wherein the plurality of user options are based on the retrieved information corresponding to the at least one physical structure at the location.

2. The apparatus of claim 1, wherein the retrieved information corresponds to climate data for a geographic region associated with the location, and wherein the plurality of user options provided for designing the solar panel layout are based on the climate data for the geographic region.

3. The apparatus of claim 1, wherein the retrieved information corresponds to structural building standards associated with the location, and wherein the plurality of user options provided for designing the solar panel layout are based on the structural building standards associated with the location.

4. The apparatus of claim 1, wherein the retrieved information corresponds to governmental financial incentive data associated with a solar panel installation at the location, and wherein the plurality of user options provided for designing the solar panel layout are based on the governmental financial incentive data.

5. The apparatus of claim 1, wherein the plurality of user options provided for designing the solar panel layout are based on a current inventory of solar panel system components available for a geographic region associated with the location.

6. The apparatus of claim 1, wherein the received data corresponding to the location comprises at least one of a street address for the at least one physical structure or global positioning system (GPS) coordinates proximate to the at least one physical structure.

7. The apparatus of claim 1, wherein the representation of the at least one physical structure comprises a satellite image retrieved from a satellite image database based on at least one of a street address for the at least one physical structure or global positioning system (GPS) coordinates proximate to the at least one physical structure.

8. The apparatus of claim 7, wherein displaying the representation of the physical structure comprises orientating the satellite image based on the direction of the equator.

9. The apparatus of claim 7, wherein the memory stores additional computer-readable instructions that, when executed, further cause the apparatus to:
identify a recognizable object of a known size within the satellite image;
determine a physical size scale for the satellite image based on the identification of the recognizable object; and
determine dimensions for one or more surfaces of the at least one physical structure using the physical size scale for the satellite image,
wherein the plurality of user options provided for designing the solar panel layout include solar panel size options based on the determined dimensions for one or more surfaces of the at least one physical structure.

10. The apparatus of claim 1, wherein the memory stores additional computer-readable instructions that, when executed, further cause the apparatus to:
receive user input via the computer user interface selecting a solar panel layout for the at least one physical structure;
identify at least one applicable form for the selected solar panel layout for the at least one physical structure, the at least one applicable form comprising at least one of a permit application form or a governmental rebate form; and
automatically populate one or more fields in the at least one applicable form based on the selected solar panel layout.

11. The apparatus of claim 1, wherein the memory stores additional computer-readable instructions that, when executed, further cause the apparatus to:
receive height data for one or more points on a roof of the at least one physical structure;
determine a surface angle for a first surface of the roof based on the received height data;
receive user input via the computer user interface selecting a solar panel type and a location on the first surface of a roof of the at least one physical structure; and
render via the computer user interface a graphical representation of a solar panel on the first surface of the roof, wherein the graphical representation of a solar panel is based on the determined surface angle for the first surface of the roof.

12. A method, comprising:
receiving data corresponding to a location having at least one physical structure;
accessing a first database and retrieving information corresponding to the at least one physical structure at the location;
providing a computer user interface displaying a representation of the at least one physical structure at the location; and
providing via the computer user interface a plurality of user options for designing a solar panel layout for the at least one physical structure, wherein the plurality of user options are based on the retrieved information corresponding to the at least one physical structure at the location.

13. The method of claim 12, wherein the retrieved information corresponds to climate data for a geographic region associated with the location, and wherein the plurality of user options provided for designing the solar panel layout are based on the climate data for the geographic region.

14. The method of claim 12, wherein the retrieved information corresponds to structural building standards associated with the location, and wherein the plurality of user options provided for designing the solar panel layout are based on the structural building standards associated with the location.

15. The method of claim 12, wherein the representation of the at least one physical structure comprises a satellite image retrieved from a satellite image database based on at least one of a street address for the at least one physical structure or global positioning system (GPS) coordinates proximate to the at least one physical structure.

16. The method of claim 15, further comprising:
identifying a recognizable object of a known size within the satellite image;
determining a physical size scale for the satellite image based on the identification of the recognizable object; and
determining dimensions for one or more surfaces of the at least one physical structure using the physical size scale for the satellite image,
wherein the plurality of user options provided for designing the solar panel layout include solar panel size options based on the determined dimensions for one or more surfaces of the at least one physical structure.

17. The method of claim 16, further comprising:
receiving input via the computer user interface selecting one or more solar panel components to be used in a solar panel layout;
generating a suggested solar panel layout for the at least one physical structure, the suggested solar panel layout comprising the selected one or more solar panel components; and
rendering the suggested solar panel layout onto the representation of the at least one physical structure in the computer user interface.

18. The method of claim 17, wherein generating the suggested solar panel layout for the at least one physical structure comprises:
identifying a physical obstruction on a roof surface of the at least one physical structure;
positioning the suggested solar panel layout to avoid the physical obstruction;
identifying a first shading factor located on or near a roof surface of the at least one physical structure;
performing a shade analysis for the first shading factor, the shaded analysis based on at least one of the position, height, or directional orientation of the first shading factor compared to the roof surface; and
positioning the suggested solar panel layout based on the shade analysis performed for the first shading factor.

19. At least one non-transitory computer-readable medium having computer-executable instructions stored thereon that, when executed, cause at least one computing device to:
receive data corresponding to a location having at least one physical structure;
access a first database and retrieve information corresponding to the at least one physical structure at the location;
provide a computer user interface displaying a representation of the at least one physical structure at the location; and
provide via the computer user interface a plurality of user options for designing a solar panel layout for the at least one physical structure, wherein the plurality of user options are based on the retrieved information corresponding to the at least one physical structure at the location.

20. The non-transitory computer-readable medium of claim 19, wherein the retrieved information corresponds to climate data for a geographic region associated with the location, and wherein the plurality of user options provided for designing the solar panel layout are based on the climate data for the geographic region.

21. The non-transitory computer-readable medium of claim 19, wherein the retrieved information corresponds to structural building standards associated with the location, and wherein the plurality of user options provided for designing the solar panel layout are based on the structural building standards associated with the location.

22. The non-transitory computer-readable medium of claim 19, wherein the representation of the at least one physical structure comprises a satellite image, and having further computer-executable instructions stored thereon that, when executed, cause at least one computing device to:
identify a recognizable object of a known size within the satellite image;
determine a physical size scale for the satellite image based on the identification of the recognizable object; and
determine dimensions for one or more surfaces of the at least one physical structure using the physical size scale for the satellite image,
wherein the plurality of user options provided for designing the solar panel layout include solar panel size options based on the determined dimensions for one or more surfaces of the at least one physical structure.
